(19) United States
(12) Patent Application Publication
(10) Pub. No.: US 2024/0157734 A1
(43) Pub. Date: May 16, 2024

(54) AIRCRAFT RADIAL TIRE

(71) Applicant: The Goodyear Tire & Rubber Company, Akron, OH (US)

(72) Inventors: Kiyoshi Ueyoko, Copley, OH (US); Badal Das, Strongsville, OH (US)

(21) Appl. No.: 18/055,510

(22) Filed: Nov. 15, 2022

(51) Int. Cl. B60C 11/04; B60C 9/20; B60C 9/26

(52) U.S. Cl. CPC B60C 11/04; B60C 9/20; B60C 9/263; B60C 2011/0386

(57) ABSTRACT

A pneumatic tire may include: a carcass; a belt reinforcing structure comprising a plurality of belt layers that include at least one spiral belt layer and at least one zigzag belt layer; and a tread comprising two or more main grooves extending circumferentially continuously around the pneumatic tire and defining a plurality of ribs that include two axially outermost ribs. At 10% to 100% of rated pressure and no load, each of the two axially outermost ribs may be raised (e.g., by a gap of 1 mm to 7 mm) in relation to a respective next nearest rib located axially inward of the respective axially outermost rib.

### FIELD OF THE INVENTION

The present disclosure relates generally to aircraft radial tires.

### BACKGROUND

Aircraft tires are subject to extreme operating conditions including a heavy load per tire coupled with high speeds. Further, prolonged taxiing can build up high heat. The foregoing and other factors cause tread wear.

When a tire spins at very high speeds, the tire experiences high angular acceleration and velocity, which can lead to uneven wear on the tire tread. Uneven tread wear can shorten the useful life of the tire because it only takes a single location of wear to get to unacceptable thickness or wear values to replace the tire, even if a majority of the tire tread is still within acceptable thickness or wear values.

Once a tread is sufficiently worn, the tire is typically re-treaded, which saves costs relative to just disposing of worn tires. Retreading may occur several times for a single tire. However, as the tread wears beyond an acceptable level, the tire is required to be removed from service and be re-treaded, which still has associated costs and down time. Therefore, extending the useful life of the tread, for example, by reducing uneven tread wear, is very desirable.

### SUMMARY

A pneumatic tire in accordance with the present disclosure may comprise: a carcass; a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure, wherein a first belt layer of the plurality of belt layers located radially outward of the carcass is one of the at least one spiral belt layer, and wherein the first belt has a belt width less than a widest belt layer of the plurality of belt layers; and a tread comprising two or more main grooves extending circumferentially continuously around the pneumatic tire and defining a plurality of ribs that include two axially outermost ribs, wherein, at 10% to 100% of rated pressure and no load, each of the two axially outermost ribs are raised in relation to a respective next nearest rib located axially inward of the respective axially outermost rib.

A pneumatic tire in accordance with the present disclosure may comprise: a carcass; a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure, wherein a first belt layer of the plurality of belt layers located radially outward of the carcass is one of the at least one spiral belt layer, and wherein the first belt has a belt width less than a widest belt layer of the plurality of belt layers; and a tread comprising two or more main grooves extending circumferentially continuously around the pneumatic tire and defining a plurality of ribs that include two axially outermost ribs and a central rib, and wherein the pneumatic tire at a rated pressure and a rated load has a footprint shape factor (FSF) of 0.8 to 0.98.

### BRIEF DESCRIPTION OF THE DRAWINGS

At least some embodiments of the present disclosure will be described by way of example and with reference to the accompanying drawings.

FIG. 1 illustrates a cross-sectional view of one half of an aircraft radial tire according to at least one embodiment of the present disclosure.

FIG. 2A illustrates a cross-sectional view of the aircraft radial tire showing the full portion of the tread. FIG. 2B illustrates an extract from FIG. 2A.

FIG. 3 illustrates a tire footprint shape for an aircraft radial tire under rated pressure and rated load.

FIGS. 4-19 illustrate nonlimiting examples of belt reinforcing structures that may be arranged between a carcass and a tread in an aircraft radial tire of the present disclosure.

FIGS. 20A, 21A, and 22A illustrate a tire footprint shape for each of the three example aircraft radial tires under rated pressure and rated load.

FIGS. 20B, 21B, and 22B illustrate tread wear patterns corresponding to the tire footprint shape illustrated in FIGS. 20A, 21A, and 22A, respectively.

### DESCRIPTION

The present disclosure relates generally to aircraft radial tires with tread configurations that may reduce uneven tread wear and, consequently, may increase the useful life of the tires.

### Definitions

The following definitions are applicable to the present invention.

“Axial” and “axially” mean lines or directions that are parallel to the axis of rotation of the tire.

“Axially inward” means in an axial direction toward the equatorial plane.

“Axially outward” means in an axial direction away from the equatorial plane.

“Bead” or “bead core” generally means that part of the tire comprising an annular tensile member of radially inner beads that are associated with holding the tire to the rim.

“Carcass” means the tire structure apart from the belt structure, tread, under tread over the plies, but including the beads.

“Circumferential” means lines or directions extending along the perimeter of the surface of the annular tread perpendicular to the axial direction.

“Equatorial plane,” “equatorial plane (EP),” or “equatorial centerplane” means the plane perpendicular to the axis of rotation of the tire and passing through the center of the tire tread.

“Groove” means an elongated void area in a tread that may extend in a circumferential, lateral or angled manner about the tread in a straight, curved, or zigzag configuration. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves have a substantially reduced depth, as compared to wide circumferential grooves which is the interconnect, they are regarded as forming “stiffener elements” tending to maintain a rib-like character in tread region involved.

“Inner” means toward the inside of the tire.

“Lateral” and “laterally” are used to indicate axial directions across the tread of the tire.

“Lateral edges” mean a line tangent to the axially outermost tread contact patch or footprint as measured under normal load and tire inflation, the lines being parallel to the equatorial centerplane.

“Monofilament” means a cord having only one filament.

“Outer” means toward the outside of the tire.

“Ply” means a continuous layer of rubber-coated parallel cords.

“Pneumatic Tire” means a laminated mechanical device of generally toroidal shape (usually an open-torus) having beads and a tread and made of rubber, chemicals, fabric and steel or other materials. When mounted on the wheel of a motor vehicle, the tire through its tread provides traction and contains the fluid that sustains the vehicle load.

“Radial” and “radially” are used to mean directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Shoulder” means the upper portion of sidewall just below the tread edge.

“Tread” means a molded rubber component which includes that portion of the tire that comes into contact with the road when the tire is normally inflated and under normal load. The tread has a depth conventionally measured from the tread outer surface to the bottom of the deepest groove of the tire.

“Turnup ply” and “turnup portion” refers to a portion of a carcass ply that wraps around one bead only.

“Zigzag belt reinforcing structure” means a belt structure formed of at least two layers of cords interwoven together wherein a ribbon of parallel cords having 1 to 20 cords in each ribbon are laid up in an alternating pattern extending at an angle typically between 5° and 45° between lateral edges of the belt, and more preferably between 3° and 11°, and most preferably between 5° and 11° degrees.

Aircraft Radial Tires and Related Methods

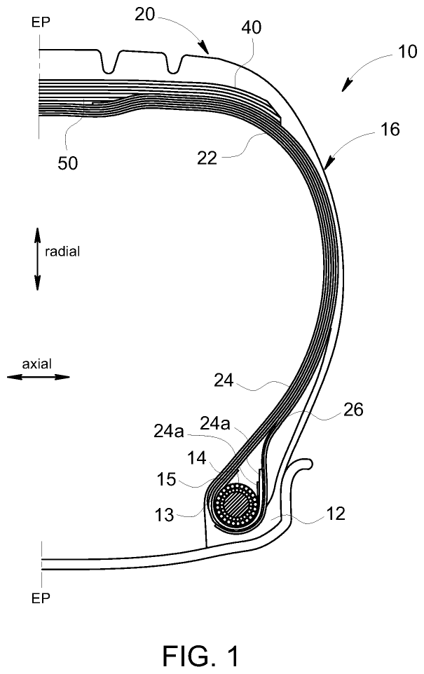

FIG. 1 illustrates a cross-sectional view of one half of an aircraft radial tire 10 (also referred to herein as an aircraft tire or a pneumatic tire or a tire) according to at least one embodiment of the present disclosure. The pneumatic tire 10 is symmetrical about the equatorial plane EP so that only one half is illustrated. As shown, the pneumatic tire 10 may comprises a pair of bead portions 12 each containing a bead 14 embedded therein. A nonlimiting example of a bead suitable for use in a pneumatic tire 10 of the present disclosure is shown in U.S. Pat. No. 6,571,847, incorporated herein by reference. The bead 14 may be preferably formed by a plurality of sheath wires 15 (e.g., steel sheath wires) surrounding a central core 13 that is a lightweight metal alloy material having a weight less than steel metal (e.g., aluminum, aluminum alloy, or other lightweight alloy such as magnesium, titanium, or any metal alloy having a weight less than steel). A person skilled in the art may appreciate that other beads may also be utilized.

The pneumatic tire 10 may further comprise a sidewall portion 16 extending substantially outward from each of the bead portions 12 in the radial direction of the pneumatic tire 10, and a tread 20 extending between the radially outer ends of the sidewall portions 16. Furthermore, the pneumatic tire 10 may be reinforced with a carcass 22 toroidally extending from one of the bead portions 12 to the other bead portion 12. The carcass 22 may be comprised of a plurality of plies include inner carcass plies 24 and outer carcass plies 26, preferably oriented in the radial direction. Among these carcass plies, typically two (or more) inner carcass plies 24 are wound around the bead 14 from inside of the pneumatic tire 10 toward outside thereof to form turnup portions 24a, while typically one (or more) outer carcass ply 26 are extended downward to the bead 14 along the outside, in the radial direction, of the turnup portion 24a of the inner carcass plies 24. Each of these carcass plies 24, 26 may comprise any suitable cord, typically nylon cords such as nylon-6,6 cords extending substantially perpendicular to the equatorial plane EP of the pneumatic tire 10 (i.e., extending in the radial direction of the tire 10). Preferably the nylon cords have an 1890 denier/2/2 or 1890 denier/3 construction. One or more of the carcass plies 24, 26 may also comprise an aramid and nylon cord structure, for example, a hybrid cord, a high energy cord or a merged cord. Examples of suitable cords are described in U.S. Pat. Nos. 4,893,665, 4,155,394 or U.S. Pat. No. 6,799,618, each of which is incorporated herein by reference.

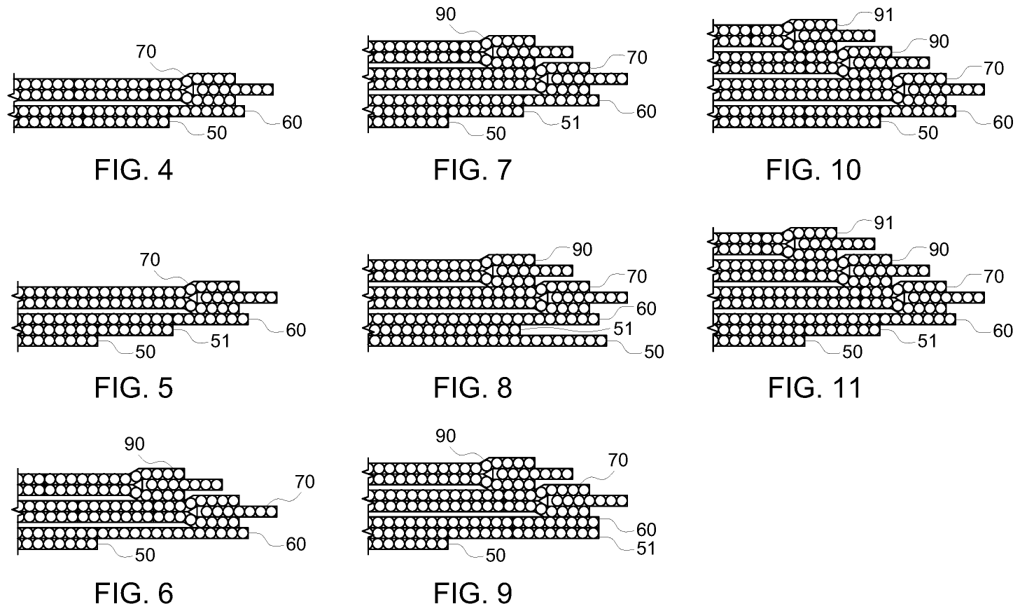

The pneumatic tire 10 further comprises a belt reinforcing structure 40 arranged between the carcass 22 and the tread 20. Several nonlimiting examples of suitable belt reinforcing structures 40 are illustrated in FIGS. 4-19 and described further herein.

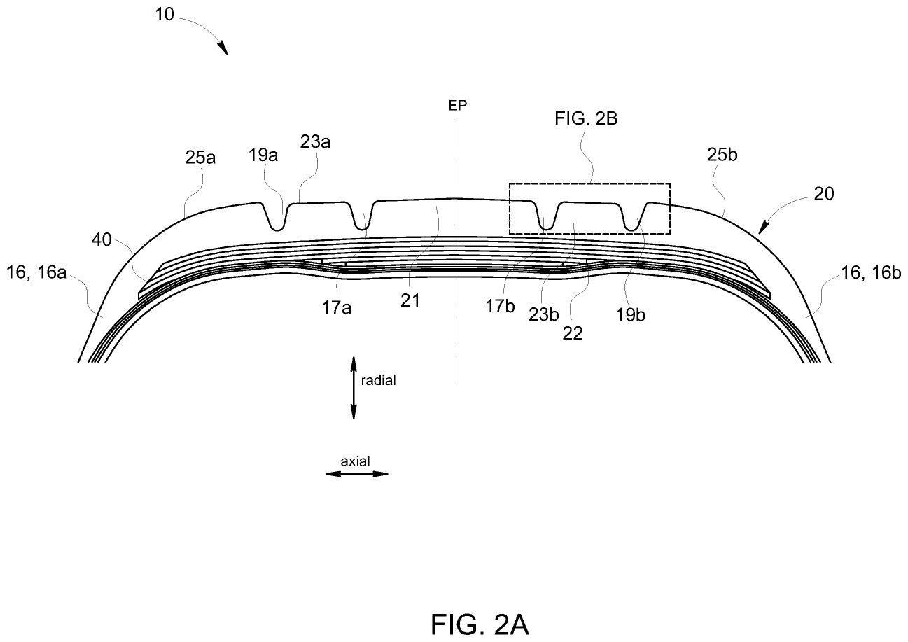

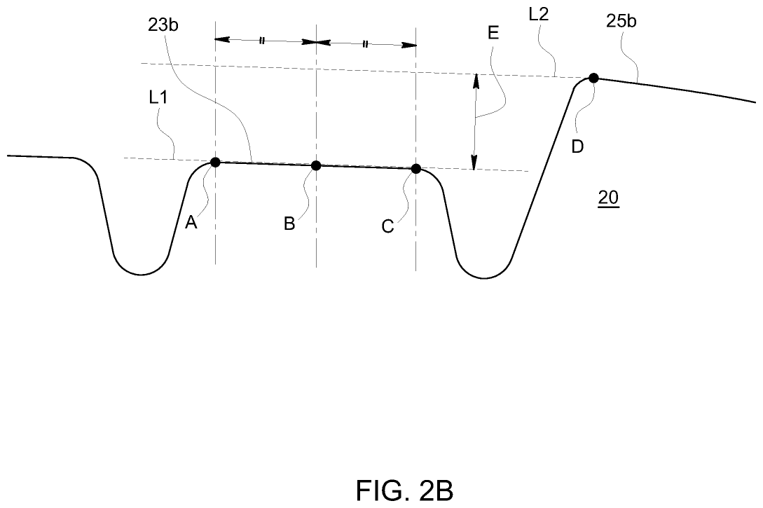

FIG. 2A, with continued reference to FIG. 1, illustrates a cross-sectional view of the pneumatic tire 10 showing the full portion of the tread 20. FIG. 2B illustrates an extract from FIG. 2A.

The tread 20 may include four main grooves 17a, 17b, 19a, 19b extending circumferentially continuously around the pneumatic tire 10 defining five ribs 21, 23a, 23b, 25a, 25b. While FIG. 2 illustrates four main grooves 17a, 17b, 19a, 19b and five ribs 21, 23a, 23b, 25a, 25b any number of main grooves and ribs may be included in an aviation pneumatic tire of the present disclosure.

The four main grooves 17a, 17b, 19a, 19b include two axially inward main grooves 17a, 17b and two axially outward main grooves 19a, 19b. The two axially inward main grooves 17a, 17b are disposed on each side of a central rib 21; thereby defining the central rib 21. A pair of intermediate ribs 23a, 23b are axially outward from the central rib 21. Each intermediate rib 23a, 23b is defined by an axially inward main groove 17a, 17b and an axially outward main groove 19a, 19b. Specifically, the intermediate rib 23a is defined by the axially inward main groove 17a and the axially outward main groove 19a, and the intermediate rib 23b is defined by the axially inward main groove 17b and the axially outward main groove 19b. Further, a pair of shoulder ribs 25a, 25b are each defined by an axially outward main groove 19a, 19b and a corresponding shoulder 16a, 16b of the pneumatic tire 10. Specifically, the shoulder rib 25a is defined by the axially outward main groove 19a and the shoulder 16a, and the shoulder rib 25b is defined by the axially outward main groove 19b and the shoulder 16b.

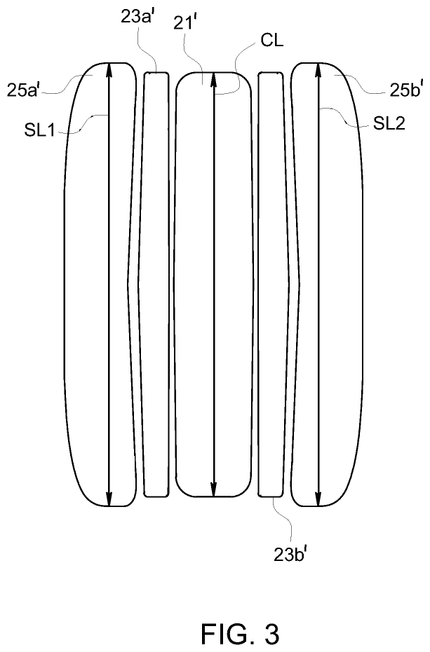

The pneumatic tires of the present disclosure have a tread configuration that may reduce uneven wear thereof. Generally, the tread of the pneumatic tires of the present disclosure may have (i) a convex shape in the radial direction at low to full inflation due to raised axially outermost ribs (i.e., the two ribs defined by a main groove and a lateral edge) (e.g., shoulder ribs 25a, 25b of FIG. 2A) and (ii) a concave footprint shape when inflated and under pressure. FIGS. 2A-2B illustrates shoulder ribs 25a, 25b of the pneumatic tire 10 being raised at 10% to 100% of rated pressure and no load, and FIG. 3 illustrates a footprint shape (specifically, a concave footprint shape) of the pneumatic tire 10 at rated pressure and rated load.

Referring to FIG. 2A, the tread configuration may be such that when the pneumatic tire 10 is at 10% to 100% of rated pressure and no load the shoulder ribs 25a, 25b (the two axially outermost ribs) are raised in relation to their respective shoulder rib 25a, 25b (their next nearest rib located axially inward therefrom). As illustrated, the shoulder rib 25a is raised in relation to the intermediate rib 23a, and the shoulder rib 25b is raised in relation to the intermediate rib 23b.

The amount an axially outermost rib (e.g., a shoulder rib 25a, 25b) is raised in relation to the next nearest rib (e.g., the respective shoulder rib 25a, 25b) located axially inward of said outermost rib may be quantified by a distance of a gap, which is illustrated as gap E in FIG. 2B. The gap E is the distance between parallel lines L1 and L2. The line L1 is defined as the line extending between points A and C. Points A and C are located an equidistance along the next nearest rib (e.g., illustrated as the intermediate rib 23b) located axially inward of the axially outermost rib (e.g., illustrated as the shoulder rib 25b) from a midpoint B of said next nearest rib. Points A and C are on the rib surface and not in the adjacent main grooves. Points A and C may be about 0.5 cm to 5 cm from the midpoint B, the value of which depend on the lateral width of the rib. The line L2 is defined as a line parallel to the line L1 and passing through point D, which is at the most radially outward point along the surface of the axially outermost rib (e.g., illustrated as the shoulder rib 25b). The gap E may be about 1 mm to about 7 mm (or about 1 mm to about 5 mm, or about 3 mm to about 7 mm).

The raised shoulder rib of the aircraft tires (e.g., pneumatic tire 10) described herein may provide more even wear across the tread when the aircraft tire is under rated pressure and rated load.

Aircraft tires (e.g., pneumatic tire 10) may have a rated pressure of about 100 psi to about 350 psi and have a rated load of about 2,000 lbs to about 75,000 lbs, which may depend on the application of size and weight of the aircraft. For example, aircraft tires with smaller dimension and carcasses and/or belt reinforcing structures with fewer plies may have a lower rated pressure and/or a lower rated load.

FIG. 3, with continued reference to FIGS. 1, 2A, and 2B, illustrates a tire footprint shape of the pneumatic tire 10 under rated pressure and rated load. The tire footprint illustrated is an outline of the ground contact of each of the five ribs 21, 23a, 23b, 25a, 25b which correspond respectively to a footprint 21′ of the central rib 21, a footprint 23a′ of the intermediate rib 23a, a footprint 23b′ of the intermediate rib 23b, a footprint 25a′ of the shoulder rib 25a, and a footprint 25b′ of the shoulder rib 25b. Preferably, the pneumatic tire 10 has a concave footprint shape under rated pressure and rated load. The footprint shape may be characterized by a footprint shape factor (FSF). The FSF is calculated according to CL=FSF*(SL1+SL2/2) where CL is a maximum length of a footprint of the central rib (e.g., the footprint 21′ of the central rib 21), SL1 is a maximum length of a footprint of a first axially outermost rib (e.g., the footprint 25a′ of the first shoulder rib 25a), and is a maximum length of a footprint of a second axially outermost rib (e.g., the footprint 25b′ of the second shoulder rib 25b). The pneumatic tire under rated pressure and rated load may have a footprint shape factor (FSF) of 0.80 to 0.98 (or 0.80 to 0.97, or 0.90 to 0.98, or 0.90 to 0.97, or 0.93 to 0.98, or 0.93 to 0.97, or 0.94 to 0.98, or 0.94 to 0.97). The FSF can be changed to square (FSF=1) or concave (or butterfly, FSF<1.0) or convex (FSF>1.0) by adjusting the values of SL1 & SL2 and CL under rated pressure and rated load. The FSF applies to aircraft tires of the present disclosure with a number of ribs other than five. For an even number of ribs, an average of the maximum length of a footprint for the two central ribs may be used for CL.

FIGS. 4-19, with continued reference to FIG. 1, illustrate nonlimiting examples of suitable belt reinforcing structures 40 that may be arranged between the carcass 22 and the tread 20. As described in FIG. 1, the pneumatic tire 10 is symmetrical about the equatorial plane EP so that only one half of each the belt reinforcing structures 40 is illustrated in FIGS. 4-19.

In each of the illustrated belt reinforcing structures 40 of FIGS. 4-19, the belt reinforcing structures 40 comprise a plurality of belt layers that include at least one spiral belt layer and at least one zigzag belt layer, each of the at least one spiral belt layers having cords arranged at an angle of 5° or less (or 3° or less) with respect to the equatorial plane EP of the pneumatic tire 10 and each of the at least one zigzag belt layers having cords arranged at an angle of 5° to 40° (or 6° to 30°) with respect to the equatorial plane EP and extending in alternation to turnaround points at each lateral edge of the belt reinforcing structure 40. Each of the plurality of belt layers may be formed of a rubberized strip of two or more cords made by spirally or helically winding the cords at an angle of plus or minus 5° or less relative to the circumferential direction.

The cords of any of the above described spiral or zigzag belt layers may comprise nylon, nylon 6,6, aramid, or combinations thereof, including merged, hybrid, or high energy constructions known to those skilled in the art. One example of a suitable cord construction for the belt cords (or carcass cords or both) may comprise a composite of aramid and nylon, containing two cords of a polyamide (aramid) with construction of 3300 dtex with a 6.7 twist, and one nylon or nylon 6/6 cord having a construction of 1880 dtex, with a 4.5 twist. The overall merged cable twist is 6.7. Preferably, the belt cords have an elongation at break greater than about 8% and less than about 26% and a break strength greater than about 400N. More preferably, the belt cords have an elongation at break in the range of about 9% to about 25%. It is additionally preferred that the ply cords have a greater elongation at break than the belt cords elongation at break. The cord properties such as percent elongation at break, linear density and tensile strength are determined from cord samples taken after being dipped but prior to vulcanization of the tire.

The belt reinforcing structures 40 may comprise a first belt layer 50 that in FIG. 1 would be located radially outward of the carcass 22. The first belt layer 50 is preferably the belt layer closest to the carcass 22. The first belt layer 50 may be a spiral belt layer. The first belt layer 50 may have a belt width in the axial direction that is less than the belt width of a widest belt layer in the belt reinforcing structure 40. The first belt layer 50 may have a width in the range of about 13% to about 100% of a rim width (width between flanges), and more particularly in the range of about 20% to about 70% of the rim width (width between flanges), and most particularly in the range of about 30% to about 42% of the rim width (width between flanges).

The configuration of the plurality of belts may be based, at least in part, on the sized and rated conditions for the pneumatic tire. In preferred embodiments, a zigzag belt layer may be the widest layer of the plurality of belts, for example, as illustrated in FIGS. 4-9.

FIG. 4 illustrates a plurality of belt layers that include the following belt layers that are layered in order according to a radially outward direction: the first belt layer 50, a second belt layer 60 as a spiral belt layer, and a third belt layer 70 as a zigzag belt layer. The first belt layer 50 is the narrowest belt layer, and the third belt layer 70 is the widest belt layer. The width of the second belt layer is between the widths of the first and third belt layers 50, 70.

FIG. 5 illustrates a plurality of belt layers that include the following belt layers that are layered in order according to a radially outward direction: the first belt layer 50, a second belt layer 51 as a spiral belt layer, a third belt layer 60 as a spiral belt layer, and a fourth belt layer 70 as a zigzag belt layer. From narrowest to widest widths along the axial direction, the plurality of belt layers are illustrated as the first belt layer 50, the second belt layer 51, the third belt layer 60, and the fourth belt layer 70.

FIG. 6 illustrates a plurality of belt layers that include the following belt layers that are layered in order according to a radially outward direction: the first belt layer 50, a second belt layer 60 as a spiral belt layer, a third belt layer 70 as a zigzag belt layer, and a fourth belt layer 90 as a zigzag belt layer. From narrowest to widest widths along the axial direction, the plurality of belt layers are illustrated as the first belt layer 50, the fourth belt layer 90, the second belt layer 60, and the third belt layer 70.

FIG. 7 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the first belt layer 50, second belt layer 51, the fifth belt layer 90, the third belt layer 60, and the fourth belt layer 70.

FIG. 8 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the second belt layer 51, the fifth belt layer 90, the first belt layer 50 and the third belt layer 60 of equal width, and the fourth belt layer 70.

FIG. 9 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the first belt layer 50, the fifth belt layer 90, the second belt layer 51 and the third belt layer 60 of equal width, and the fourth belt layer 70.

FIG. 10 illustrates a plurality of belt layers that include the following belt layers that are layered in order according to a radially outward direction: the first belt layer 50, a second belt layer 60 as a spiral belt layer, a third belt layer 70 as a zigzag belt layer, a fourth belt layer 90 as a zigzag belt layer, and a fifth belt layer 91 as a zigzag belt layer. From narrowest to widest widths along the axial direction, the plurality of belt layers are illustrated as the first belt layer 50 and the fifth belt layer 91 of equal width, the fourth belt layer 90, the second belt layer 60, and the third belt layer 70.

FIG. 11 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, a fifth belt layer 90 as a zigzag belt layer, and a sixth belt layer 91 as a zigzag belt layer. From narrowest to widest widths along the axial direction, the plurality of belt layers are illustrated as the first belt layer 50, the second belt layer 51 and the fifth belt layer 91 of equal width, the fifth belt layer 90, the third belt layer 60, and the fourth belt layer 70.

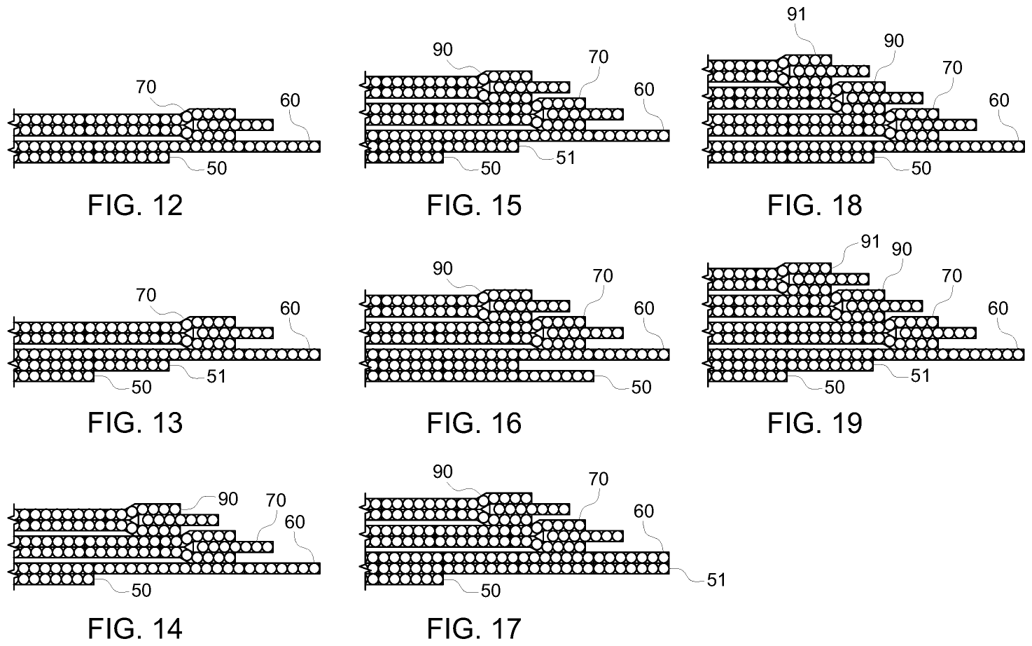

FIG. 12 illustrates a plurality of belt layers that include the following belt layers that are layered in order according to a radially outward direction: the first belt layer 50, a second belt layer 60 as a spiral belt layer, and a third belt layer 70 as a zigzag belt layer. From narrowest to widest widths along the axial direction, the plurality of belt layers are illustrated as the first belt layer 50, the third belt layer 70, and the second belt layer 60.

FIG. 13 illustrates a plurality of belt layers that include the following belt layers that are layered in order according to a radially outward direction: the first belt layer 50, a second belt layer 51 as a spiral belt layer, a third belt layer 60 as a spiral belt layer, and a fourth belt layer 70 as a zigzag belt layer. From narrowest to widest widths along the axial direction, the plurality of belt layers are illustrated as the first belt layer 50, the second belt layer 51, the fourth belt layer 70, and the third belt layer 60.

FIG. 14 illustrates a plurality of belt layers that include the following belt layers that are layered in order according to a radially outward direction: the first belt layer 50, a second belt layer 60 as a spiral belt layer, a third belt layer 70 as a zigzag belt layer, and a fourth belt layer 90 as a zigzag belt layer. From narrowest to widest widths along the axial direction, the plurality of belt layers are illustrated as the first belt layer 50, the fourth belt layer 90, the third belt layer 70, and the second belt layer 60.

FIG. 15 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the first belt layer 50, the second belt layer 51, the fifth belt layer 90, the fourth belt layer 70, and the third belt layer 60.

FIG. 16 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the second belt layer 51, the fifth belt layer 90, the first belt layer 50, the fourth belt layer 70, and the third belt layer 60.

FIG. 17 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, and a fifth belt layer 90 as a zigzag belt layer. From narrowest to widest widths along the axial direction, the plurality of belt layers are illustrated as the first belt layer 50, the fifth belt layer 90, the fourth belt layer 70, and of equal width the second belt layer 51 and the third belt layer 60.

FIG. 18 illustrates a plurality of belt layers that include the following belt layers that are layered in order according to a radially outward direction: the first belt layer 50, a second belt layer 60 as a spiral belt layer, a third belt layer 70 as a zigzag belt layer, a fourth belt layer 90 as a zigzag belt layer, and a fifth belt layer 91 as a zigzag belt layer. From narrowest to widest widths along the axial direction, the plurality of belt layers are illustrated as the first belt layer 50 and the fifth belt layer 91 of equal width, the fourth belt layer 90, the third belt layer 70, and the second belt layer 60.

FIG. 19 illustrates a plurality of belt layers that include the following belt layers that are layered in order according to a radially outward direction: the first belt layer 50, a second belt layer 51 as a spiral belt layer, a third belt layer 60 as a spiral belt layer, a fourth belt layer 70 as a zigzag belt layer, a fifth belt layer 90 as a zigzag belt layer, and a sixth belt layer 91 as a zigzag belt layer. From narrowest to widest widths along the axial direction, the plurality of belt layers are illustrated as the first belt layer 50, second belt layer 51 and sixth fifth belt layer 91 of equal width, the fifth belt layer 90, the fourth belt layer 70, and the third belt layer 60.

In any of the above described embodiments, the cords may be preferably continuously wound from one belt layer to the next.

The composition of the various components of the aircraft tires described herein may be traditional materials used in the construction of aircraft tires.

Examples of rubbers suitable for use in the tread, belt reinforcing structure, carcass, and other portions of the aircraft tire traditionally made of or containing rubber may include, but are not limited to, neoprene (polychloroprene), polybutadiene (including cis-1,4-polybutadiene), polyisoprene (including cis-1,4-polyisoprene) (natural or synthetic), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM) (e.g., ethylene/propylene/dicyclopentadiene terpolymers), alkoxy-silyl end functionalized solution polymerized polymers (SBR, PBR, IBR and SIBR), silicon-coupled, tin-coupled star-branched polymers, the like, and any combination thereof.

The foregoing rubbers may also contain conventional rubber compounding ingredients including processing oil, accelerators, conventional sulfur curing agents, pigments, carbon black, zinc oxide, stearic acid, tackifying resin, and plasticizer.

### Nonlimiting Example Embodiments

Embodiment 1. A pneumatic tire comprising: a carcass; a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure, wherein a first belt layer of the plurality of belt layers located radially outward of the carcass is one of the at least one spiral belt layer, and wherein the first belt has a belt width less than a widest belt layer of the plurality of belt layers; and a tread comprising two or more main grooves extending circumferentially continuously around the pneumatic tire and defining a plurality of ribs that include two axially outermost ribs, wherein, at 10% to 100% of rated pressure and no load, each of the two axially outermost ribs are raised in relation to a respective next nearest rib located axially inward of the respective axially outermost rib.

Embodiment 2. The pneumatic tire of Embodiment 1, wherein the pneumatic tire at a rated pressure and a rated load has a footprint shape factor (FSF) of 0.8 to 0.98.

Embodiment 3. The pneumatic tire of Embodiment 1, wherein the pneumatic tire at a rated pressure and a rated load has a footprint shape factor (FSF) of 0.9 to 0.98.

Embodiment 4. The pneumatic tire of Embodiment 1, wherein the pneumatic tire at a rated pressure and a rated load has a footprint shape factor (FSF) of 0.93 to 0.98.

Embodiment 5. The pneumatic tire of any one of Embodiments 1-4, wherein the two or more main grooves are four main grooves and the plurality of ribs is five ribs; wherein the two axially outermost ribs are a pair of shoulder ribs; and wherein the four main grooves and five ribs include two axially inward main grooves disposed on each side of a central rib, two axially outward main grooves, a pair of intermediate ribs each defined by adjacent axially inward and axially outward main grooves, and the pair of shoulder ribs each defined by a axially outward main groove and corresponding shoulder of the pneumatic tire.

Embodiment 6. The pneumatic tire of any one of Embodiments 1-5, wherein each of the two axially outermost ribs are raised by a gap of 1 mm to 7 mm in relation to the respective next nearest rib located axially inward of the respective axially outermost rib.

Embodiment 7. The pneumatic tire of any one of Embodiments 1-6, wherein a second belt layer of the belt reinforcing structure located radially outward of the first belt layer is one of the at least one zigzag belt layers, wherein the cords of the second belt layer are arranged at an angle of 6° to 30° with respect to the equatorial plane.

Embodiment 8. The pneumatic tire of Embodiment 7, wherein the cords of the second belt layer comprise a polyamide and/or an aromatic polyamide.

Embodiment 9. The pneumatic tire of any one of Embodiments 1-8, wherein the cords of the first belt layer are arranged at an angle of 3° or less with respect to an equatorial plane.

Embodiment 10. The pneumatic tire of any one of Embodiments 1-9, wherein the cords of the first belt layer comprise a polyamide and/or an aromatic polyamide.

Embodiment 11. The pneumatic tire of any one of Embodiments 1-6 or 9-10, wherein a second belt layer of the belt reinforcing structure located radially outward of the first belt layer is one of the at least one spiral belt layers.

Embodiment 12. The pneumatic tire of Embodiment 11, wherein a third belt layer of the belt reinforcing structure located radially outward of the second belt layer is one of the at least one zigzag belt layers.

Embodiment 13. The pneumatic tire of any one of Embodiments 1-12, wherein the first belt has a narrowest belt layer in the axial direction of the plurality of belt layers.

Embodiment 14. The pneumatic tire of any one of Embodiments 1-13 further comprising: a bead formed by a plurality of sheath wires surrounding a central core that is a lightweight metal alloy material having a weight less than steel metal.

Embodiment 15. The pneumatic tire of Embodiment 14, wherein the carcass comprises a plurality of carcass plies wound around the bead, and wherein cords of the plurality of carcass plies comprise a polyamide and/or an aromatic polyamide.

Embodiment 16. A pneumatic tire comprising: a carcass; a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure, wherein a first belt layer of the plurality of belt layers located radially outward of the carcass is one of the at least one spiral belt layer, and wherein the first belt has a belt width less than a widest belt layer of the plurality of belt layers; and a tread comprising two or more main grooves extending circumferentially continuously around the pneumatic tire and defining a plurality of ribs that include two axially outermost ribs and a central rib, and wherein the pneumatic tire at a rated pressure and a rated load has a footprint shape factor (FSF) of 0.8 to 0.98.

Embodiment 17. The pneumatic tire of Embodiment 16, wherein a second belt layer of the belt reinforcing structure located radially outward of the first belt layer is one of the at least one zigzag belt layers, wherein the cords of the second belt layer are arranged at an angle of 6° to 30° with respect to the equatorial plane.

Embodiment 18. The pneumatic tire of Embodiment 17, wherein the cords of the second belt layer comprise a polyamide and/or an aromatic polyamide.

Embodiment 19. The pneumatic tire of Embodiment 16, wherein a second belt layer of the belt reinforcing structure located radially outward of the first belt layer is one of the at least one spiral belt layers.

Embodiment 20. The pneumatic tire of any one of Embodiments 16-19, wherein the cords of the first belt layer are arranged at an angle of 3° or less with respect to an equatorial plane.

Embodiment 21. The pneumatic tire of any one of Embodiments 16-20, wherein the cords of the first belt layer comprise a polyamide and/or an aromatic polyamide.

Embodiment 22. The pneumatic tire of any one of Embodiments 16-21, wherein the FSF is 0.9 to 0.98.

Embodiment 23. The pneumatic tire of any one of Embodiments 16-22, wherein the FSF is 0.93 to 0.98.

Embodiment 24. The pneumatic tire of any one of Embodiments 16-23, wherein the two or more main grooves are four main grooves and the plurality of ribs is five ribs; wherein the two axially outermost ribs are a pair of shoulder ribs; and wherein the four main grooves and five ribs include two axially inward main grooves disposed on each side of the central rib, two axially outward main grooves, a pair of intermediate ribs each defined by adjacent axially inward and axially outward main grooves, and the pair of shoulder ribs each defined by a axially outward main groove and corresponding shoulder of the pneumatic tire.

Embodiment 25. The pneumatic tire of any one of Embodiments 16-24, wherein each of the two axially outermost ribs are raised in relation to a respective next nearest rib located axially inward of the respective axially outermost rib.

Embodiment 26. The pneumatic tire of any one of Embodiments 16-25, wherein each of the two axially outermost ribs are raised by a gap of 1 mm to 7 mm in relation to the respective next nearest rib located axially inward of the respective axially outermost rib.

To facilitate a better understanding of the embodiments of the present invention, the following examples of preferred or representative embodiments are given. In no way should the following examples be read to limit, or to define, the scope of the invention.

### EXAMPLES

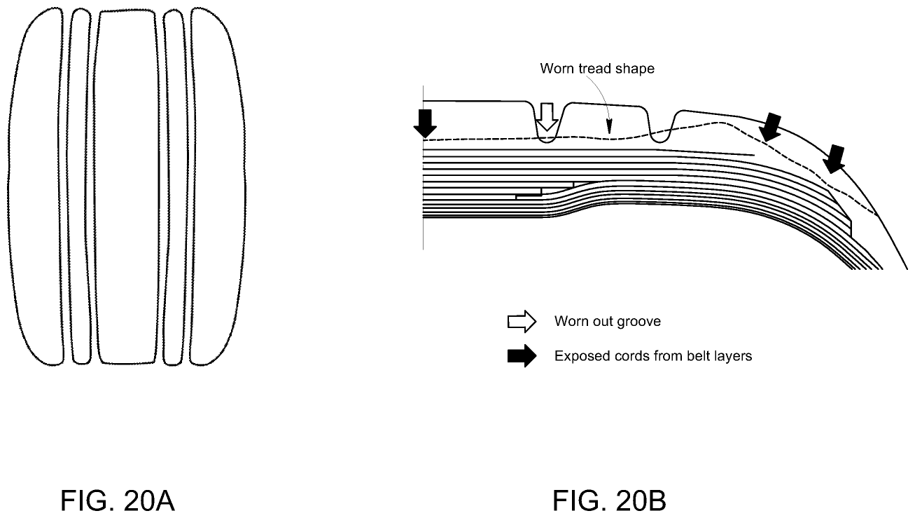

The wear performance for three pneumatic aircraft tires with different tread configurations were tested. The tread configuration for Tire 1 (comparative tire) does not meet either of the conditions of (i) a raised shoulder rib when at 10% to 100% of rated pressure and no load or (ii) a FSF of 0.80 to 0.98 when at rated pressure and rated load. The tread configurations for Tire 2 and Tire 3 (inventive tires) do meet said condition. The footprint shape factor of each tire was measured before the tread wear performance and is reported in Table 1. A tire footprint shape of each of the three tires under rated pressure and rated load is illustrated in FIGS. 20A, 21A, and 22A. Comparing these figures, respectively, Tire 1 has a square or flat shape, Tire 2 has a very concave footprint shape, and Tire 3 has an intermediate concave footprint shape.

The three tires were tested for tread wear performance measured under in door drum testing conditions, which is a taxiing test under lower speed like a 10 to 12 mph with 70 to 80% rated load free rolling condition. After 4000 miles running, the treads were inspected to compare tread loss and predict entire tread wear profile in service. The tread wear performance values are provided in Table 1. The predicted tread wear profile for each tire is illustrated in FIGS. 20B, 21B, and 22B. Tire 1 has uneven wear focused near the equatorial plane and axially outward edges of the tread. Tire 2 has more even wear than Tire 1 but is focused at the axially outward main groove and axial edges of the tread. Tire 3 has the most even wear showing similar wear at both the axially inward and outward main grooves while also exposing cords of the belt layers. That is, axially across the tread of Tire 3 similar wear is shown.

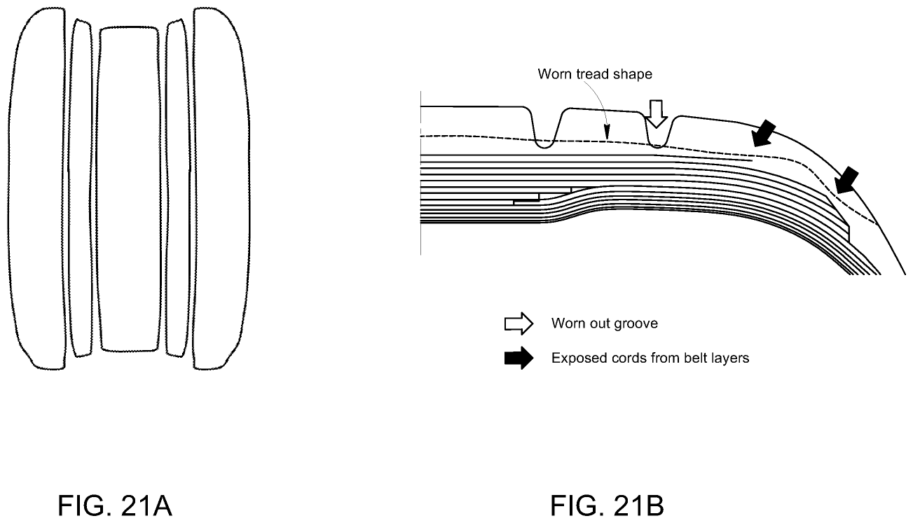

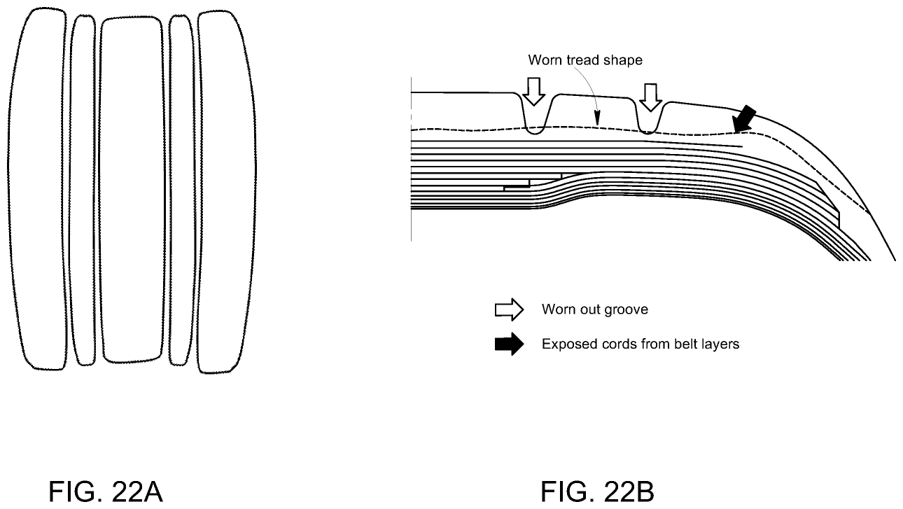

TABLE 1

| | | | Tread Wear | |
|---|---|---|---|---|
| | Footprint Shape | Footprint | Performance | Tread Wear |
| | Factor | Shape | (index) | Pattern |
| Tire 1 | 1.0 | FIG. 20A | 100 | FIG. 20B |
| Tire 2 | 0.92 | FIG. 21A | 110 | FIG. 21B |
| Tire 3 | 0.96 | FIG. 22A | 125-130 | FIG. 22B |

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present invention are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A pneumatic tire comprising:
a carcass;
a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure,
wherein a first belt layer of the plurality of belt layers located radially outward of the carcass is one of the at least one spiral belt layer, and
wherein the first belt has a belt width less than a widest belt layer of the plurality of belt layers; and
a tread comprising two or more main grooves extending circumferentially continuously around the pneumatic tire and defining a plurality of ribs that include two axially outermost ribs,
wherein, at 10% to 100% of a rated pressure and no load, each of the two axially outermost ribs are raised in relation to a respective next nearest rib located axially inward of the respective axially outermost rib by a gap E,
wherein, the gap E is the distance between a line L1 that is parallel to a line L2, the line L1 is defined as a line extending between points A and C that located an equidistance along the next nearest rib surface from a midpoint B of the next nearest rib surface, wherein the points A and C are each 0.5 cm to 5 cm from the midpoint B, the line L2 is defined as a line parallel to the line L1 and passing through a point D that is at a most radially outward point along a surface of the axially outermost rib, and the gap E is 1 mm to 7 mm.

2. The pneumatic tire of claim 1, wherein the pneumatic tire at the rated pressure and a rated load has a footprint shape factor (FSF) of 0.8 to 0.98.

3. The pneumatic tire of claim 1, wherein the pneumatic tire at the rated pressure and a rated load has a footprint shape factor (FSF) of 0.9 to 0.98.

4. The pneumatic tire of claim 1, wherein the pneumatic tire at the rated pressure and a rated load has a footprint shape factor (FSF) of 0.93 to 0.98.

5. The pneumatic tire of claim 1, wherein the two or more main grooves are four main grooves and the plurality of ribs is five ribs; wherein the two axially outermost ribs are a pair of shoulder ribs; and wherein the four main grooves and five ribs include two axially inward main grooves disposed on each side of a central rib, two axially outward main grooves, a pair of intermediate ribs each defined by adjacent axially inward and axially outward main grooves, and the pair of shoulder ribs each defined by an axially outward main groove and corresponding shoulder of the pneumatic tire.

6. (canceled)

7. The pneumatic tire of claim 1, wherein a second belt layer of the belt reinforcing structure located radially outward of the first belt layer is one of the at least one zigzag belt layers, wherein the cords of the second belt layer are arranged at an angle of 6° to 30° with respect to the equatorial plane.

8. The pneumatic tire of claim 7, wherein the cords of the second belt layer comprise a polyamide and/or an aromatic polyamide.

9. The pneumatic tire of claim 1, wherein the cords of the first belt layer are arranged at an angle of 3° or less with respect to an equatorial plane.

10. The pneumatic tire of claim 1, wherein the cords of the first belt layer comprise a polyamide and/or an aromatic polyamide.

11. The pneumatic tire of claim 1, wherein a second belt layer of the belt reinforcing structure located radially outward of the first belt layer is one of the at least one spiral belt layers.

12. The pneumatic tire of claim 11, wherein a third belt layer of the belt reinforcing structure located radially outward of the second belt layer is one of the at least one zigzag belt layers.

13. The pneumatic tire of claim 1, wherein the first belt has a narrowest belt layer in the axial direction of the plurality of belt layers.

14. The pneumatic tire of claim 1 further comprising:
a bead formed by a plurality of sheath wires surrounding a central core that is a lightweight metal alloy material comprising one of an aluminum, an aluminum alloy, a magnesium, or a titanium.

15. The pneumatic tire of claim 14, wherein the carcass comprises a plurality of carcass plies wound around the bead, and wherein cords of the plurality of carcass plies comprise a polyamide and/or an aromatic polyamide.

16. A pneumatic tire comprising:
a carcass;
a belt reinforcing structure comprising a plurality of belt layers that include at least one spiral belt layer and at least one zigzag belt layer, each of the at least one spiral belt layers having cords arranged at an angle of 5° or less with respect to an equatorial plane of the pneumatic tire and each of the at least one zigzag belt layers having cords arranged at an angle of 5° to 40° with respect to the equatorial plane and extending in alternation to turnaround points at each lateral edge of the belt reinforcing structure,
wherein a first belt layer of the plurality of belt layers located radially outward of the carcass is one of the at least one spiral belt layer, and
wherein the first belt has a belt width less than a widest belt layer of the plurality of belt layers; and
a tread comprising two or more main grooves extending circumferentially continuously around the pneumatic tire and defining a plurality of ribs that include a first axially outermost, a second axially outermost rib, and a central rib, and
wherein the pneumatic tire at a rated pressure and a rated load has a footprint shape factor (FSF) calculated according to
$$CL = FSF * ( \frac{SL 1 + SL 2}{2} )$$
where CL is a maximum length of a footprint of the central rib, SL1 is a maximum length of a footprint of the first axially outermost rib, and SL2 is a maximum length of a footprint of a second axially outermost rib, and the footprint shape factor (FSF) is 0.94 to 0.98.

17. The pneumatic tire of claim 16, wherein a second belt layer of the belt reinforcing structure located radially outward of the first belt layer is one of the at least one zigzag belt layers, wherein the cords of the second belt layer are arranged at an angle of 6° to 30° with respect to the equatorial plane.

18. The pneumatic tire of claim 17, wherein the cords of the second belt layer comprise a polyamide and/or an aromatic polyamide.

19. The pneumatic tire of claim 16, wherein the cords of the first belt layer are arranged at an angle of 3° or less with respect to an equatorial plane.

20. The pneumatic tire of claim 16, wherein the cords of the first belt layer comprise a polyamide and/or an aromatic polyamide.
